(19) United States
(12) Patent Application Publication
(10) Pub. No.: US 2026/0352707 A1
(43) Pub. Date: Nov. 5, 2026

(54) APPARATUS AND METHOD FOR DETECTION OF MALICIOUS WEBSITES

(71) Applicant: Sheffield Hallam University, Sheffield (GB)

(72) Inventor: Abdel-Karim Al-Tamimi, Sheffield (GB)

(21) Appl. No.: 19/488,458

(22) PCT Filed: May 31, 2024
(86) PCT No.: PCT/GB2024/051415

§ 371 Date: Nov. 26, 2025

(30) Foreign Application Priority Data
Jun. 1, 2023 (GB) 2308223.3

(51) Int. Cl. H04L 9/40; H04L 9/00; H04L 9/32

(52) U.S. Cl. CPC H04L 63/1483; H04L 9/3236; H04L 9/50; H04L 63/0884

(57) ABSTRACT

The present invention provides a computer implemented method for the detection of malicious websites utilising the visual similarity between a potentially malicious website and a legitimate website to add the site to a cautious list. Consensus is then used to add the entry to a black list.

### TECHNICAL FIELD

The present invention related to an apparatus and method for detection of malicious websites. More specifically, the present invention provides an apparatus and method for identifying malicious websites that are visually similar to authentic websites and distributing information relevant thereto via a blockchain.

### BACKGROUND ART

“Phishing” is a form of cyber attack whereby a malicious website is used to prompt a user to enter confidential information. For example, a phishing site may require a user to input a username and password for a legitimate site. The user, thinking that the malicious site is genuine, inputs the information and thus passes their login details to the operator of the phishing site, giving them access to the authentic user account. Similarities in the visual and text content of phishing sites give them the veneer of credibility.

Phishing attacks may be perpetrated via communication pathways such as email, SMS etc., in which a malicious link is provided which appears to be authentic. The link directs the user to a site that also appears authentic (it may be a reproduction of the genuine site). The malicious site will commonly have a similar appearance to the genuine site-using the same or similar copy, logos, colours and layout. The only noticeable difference is the URL, which the user may not review before inputting their details (assuming a level of authenticity).

“Spear-phishing” attacks are used to target specific individuals or groups. Such attacks use publicly available personal information (e.g. from business profile sites, or social media) to make the attack more believable for the target by posing as a person or company the target trusts.

Such attacks may be more focussed on specific groups of users whose personal data, or data to which they have access, is particularly valuable. For example those that have access to financial information, or the accounts of employees or users. These may be C-suite executives, for example. When this is the case, the technique is commonly referred to as “whaling”.

Evidently these types of attack can be more damaging than mass-phishing.

There are various methods of dealing with this problem in the prior art.

Typical phishing detection techniques rely either on the URLs or the HTML contents to extract textual features related to the visited websites then compare them to dynamic and ever-expanding database of phishing websites. If matched, the URL is blacklisted. This matching process may be carried out by e.g., machine learning (ML).

For example, Google (RTM) is estimated to identify and block 40,000 URLs every week. This type of approach suffers from serious limitations:
1. the gathered phishing datasets are typically biased (more phishing websites than legitimate websites) that lead to biased models in which the ML model is disproportionally trained using one possible case scenario (or class) versus others;
2. these datasets are quite extensive and require a lot of resources to maintain and share; and,
3. there is no visual explanation of the prediction results to tone/improve over time.

A further method is to use analysis of visual similarity. Visual similarities may be computed instead to detect phishing websites in a comparable fashion to how security analysts identify these websites manually. SIFT (Scale-Invariant Feature Transform) and SURF (Speeded Up Robust Features) image processing techniques were proposed to compare websites screenshots with existing databases of protected (genuine) websites. These approaches focus only on the logos of visited websites to mitigate the impact of the frequent changes of websites content and layout. However, they are typically inaccurate compared to other methods, especially for websites that depend on customized SSO login pages, and it could take up to 19 seconds to process one website. In addition to that, phishing websites rely more on the overall layout and can use other visual similarities such as colour schemes to trick users.

Taking a screenshot of the entire page and comparing it to genuine websites would lead to better overall results but such an approach suffers from three main drawbacks:
1. there is a linear search complexity associated with matching the tested website against stored datasets, which increases the processing time linearly with more websites to compare and protect;
2. the associated computation time with processing screenshots could be prohibitively costly in time and resources; and,
3. there may still be a tendency to misclassify websites when they change layout/colour scheme.

In short, the existing methods are data-intensive and slow. This is problematic in particular for so-called “zero day” attacks, in which the phishing website is up and running before the database has been updated.

It is an aim of the present invention to overcome, or at least mitigate, the above problems.

### SUMMARY OF INVENTION

According to a first aspect of the present invention there is provided a computer implemented method for the detection of malicious websites, the method comprising the steps of:
providing a plurality of client computing devices connected to a network;
providing a distributed store of legitimate websites, the distributed store of legitimate websites comprising hashed image data of legitimate websites, in the form of hashes representative of the visual features of an image of each respective legitimate website;
providing a database of potentially malicious websites;
providing a database of legitimate websites;
using a first client computing device of the plurality of client computing devices to visit a website;
undertaking a first verification step to verify the visited website against the database of potentially malicious websites, if the visited website can be verified against the database of potentially malicious websites alert the user, otherwise:
undertaking a second verification step to verify the visited website against the database of legitimate websites; and,
   if the visited website cannot be verified against the database of legitimate websites:
   capturing a graphical impression of the visited website as an image;
   hashing the image of the visited website to create hashed image data of the visited website;
   comparing the hashed image data of the visited website to the hashed image data of legitimate websites in the distributed store of legitimate websites to determine whether the visited website is visually similar to any of the legitimate websites;
   if the visited website is visually similar to at least one of the legitimate websites:
      adding the visited website to a ‘cautious list’ distributed store;
      seeking consensus across the network that the visited website from which the hashed image data is derived cannot be verified and is visually similar to a legitimate website; and,
      if consensus is reached, adding the website to the database of potentially malicious websites.

By “distributed store” we mean a store or database of data that is stored across a plurality of locations.

Advantageously the present invention does not rely solely on a ‘white list’ (also known as an ‘allowed website list’ according to NCSC recommendations) (or ‘black list’ (known as a ‘blocked website list’ according to NCSC recommendations)) of URLs, such a system being vulnerable to zero day attack. Instead, the visual similarity of the website to a legitimate website is used to determine whether the site is suspicious, and a distributed database consensus mechanism used to determine whether the site is malicious. The use of a distributed database means that the system of the present invention can be highly reactive to malicious websites, reducing the likelihood of zero day attacks succeeding. The use of a consensus process mitigates the risks of malicious users falsely reporting legitimate websites.

In an embodiment the distributed database of legitimate website hashes is a blockchain. In an embodiment the ‘cautious list’ distributed database is a blockchain.

Preferably, the database of potentially malicious websites and/or the database of legitimate websites comprise website address data.

Preferably, the database of potentially malicious websites and/or the database of legitimate websites are blockchains.

Preferably, the database of potentially malicious websites and/or the database of legitimate websites are read only blockchains for a majority subset of the plurality of client computing devices.

Preferably, the step of hashing the image comprises the step of generating a hash using an algorithm in which visual features are extracted using a pre-trained vision transformer.

Preferably, feature vectors generated by the pre-trained vision transformer are hashed using LSH (Locality Sensitive Hashing).

Preferably, the method comprises the steps of:
providing a server connected to the network;
storing a primary version of the blockchain of legitimate website hashes on the server;
storing local versions of the blockchain of legitimate website hashes on at least some of the plurality of client computing devices; and,
periodically updating the local versions of the blockchain of legitimate website hashes from the primary version of the blockchain of legitimate website hashes.

Preferably, consensus is achieved with a limited subset of approvers.

Preferably, consensus is achieved using the proof of authority consensus mechanism.

Preferably, the method comprises the steps of:
providing a server connected to the network;
undertaking the step of hashing on behalf of or more client computing devices using the server.

The invention also provides a computer implemented method according to any preceding claim, wherein the network is connected to the internet.

Preferably the method comprises the step of undertaking a third verification step, prior to the second verification step, by checking whether the website comprises user entry fields, if the website does not comprise user entry fields, stopping the method. The first and third steps can occur in any order. Advantageously, this prevents the method from continuing if the website does not present a phishing risk (i.e., does not accept user data in any form).

The verification steps may be carried out by the first client computing device, for example by a browser extension stored and executed on the first client computing device.

Alternatively, the first client computing device is connected to the network via a proxy server, wherein the verification steps are carried out by the proxy server. Advantageously at least one further client computing device is connected to the network via the proxy server, and the proxy server is configured to control access to websites from each of the client computing devices connected to the proxy server based on the verification steps.

In one embodiment, the computer implemented method, comprises the steps of:
storing data about each of the plurality of client computing devices and/or users of each of the client computing devices;
creating a database of visited websites added to the ‘cautious list’ distributed store against the data about the client computing device from which the website was visited;
identifying a pattern in the database identifying a class of client computing devices or users thereof under attack;
producing an alert to users or organisation of users in the same class.

The data about each of the plurality of client computing devices and/or users of each of the client computing devices may comprise one or more of:
the geographical location of the local machine;
the network location of the local machine;
the organisation in which the local machine is deployed;
the industry in which the local machine is deployed;
the position of the user of the local machine;
the department of the user of the local machine;
the level of access the user of the local machine has to sensitive data; and,
personal details of the user of the local machine.

The invention also provides a data processing system comprising means for carrying out the above method.

The invention also provides a computer program comprising instructions which, when the program is executed by a computer, cause the computer to carry out the method of the above method.

The invention also provides a computer-readable medium comprising instructions which, when executed by a computer, cause the computer to carry out the method of any of the above method.

### BRIEF DESCRIPTION OF DRAWINGS

An embodiment of the present invention will now be described with reference to the following figure in which:

FIG. 1 is a schematic view of a first apparatus in accordance with the present invention;

FIG. 2 is a flow chart of the method of operation of the apparatus of FIG. 1;

FIG. 3 is a schematic view of a second apparatus in accordance with the present invention.

### DESCRIPTION OF THE FIRST EMBODIMENT

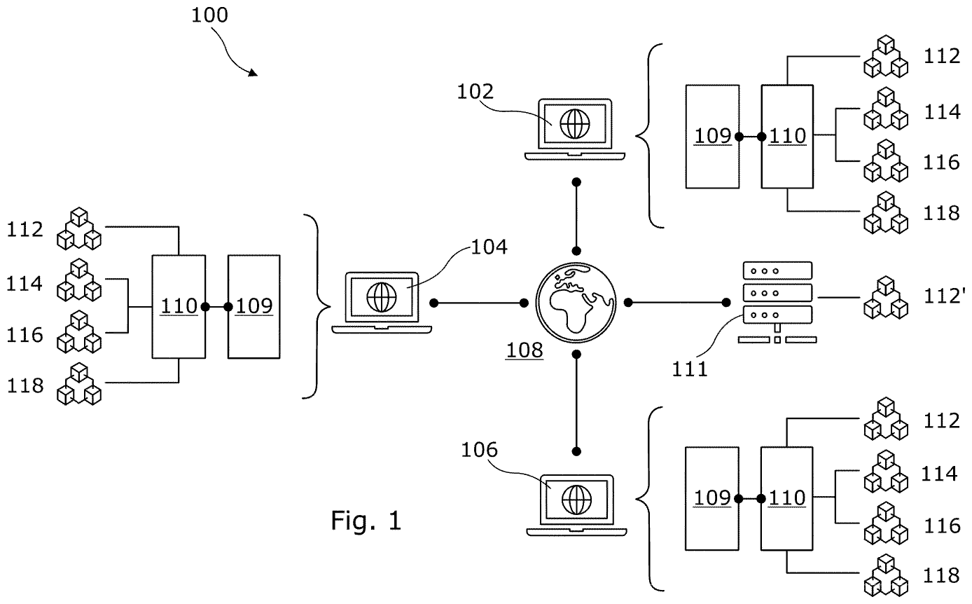

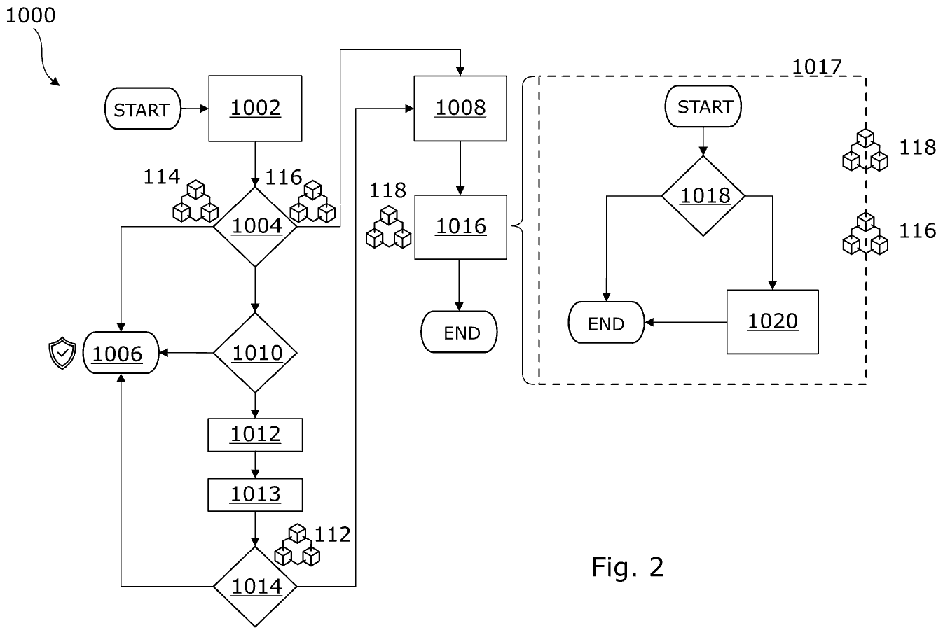

An apparatus according to the present invention is shown in FIG. 1, with the associated method in FIG. 2.

Referring to FIG. 1, apparatus 100 according to the present invention comprises a plurality of connected computers (clients) 102, 104, 106 . . . each connected to a network 108. The network 108, in this example, is the internet. An enterprise grade server 111 is also connected to the network 108.

Each computer 102, 104, 106 comprises an internet browser 109. The browser 109 is provided with phishing prevention software 110 according to the present invention. The software 110 has access to locally stored copies of four blockchains:
Blockchain of protected hashes 112;
White list URL blockchain 114;
   For a typical user of one of the devices 102, 104, 106, this is a read only blockchain. The URLs within the blockchain are verified by a system service provider for well-known URLs and/or websites subscribed to the service (‘allowed website list’);
Black list URL blockchain 116; and,
   For a typical user of one of the devices 102, 104, 106, this is a read only blockchain. The URLs within the blockchain are either:
      well-known malicious domains provided by the system service provider (‘blocked website list’); and,
      updated by the service users through the consensus process;
Cautious list (or ‘amber’ list) URL blockchain 118;
   For a typical user of one of the devices 102, 104, 106, this has read and write permissions.

The blockchain of protected hashes 112 contains hashes of images of verified websites. For example, it may contain a hash of the image of a genuine banking or social media website login page. The blockchain 112 only contains information with a high degree of trust. This may be established in several ways, for example (i) by reaching consensus across the blockchain network comprising computers 102, 104, 106 etc, (ii) by verification with trusted partners and/or (iii) with verified collaboration from the website owners. The same is true for the white list URL blockchain 114.

The hashes within the blockchain 112 are representative of the graphical features of the websites they represent. More specifically, each hash has been generated using an algorithm in which visual features are extracted using a pre-trained vision transformer (VGG—Visual Geometry Group model, for example). The generated feature vectors are then hashed using LSH (Locality Sensitive Hashing) to divide them into ‘buckets’ to perform the comparisons only on hashes in these buckets (i.e. similarity search). This reduces the search complexity from linear order O(N) to logarithmic order O(logN). The process is configured to produce a hash that is representative of the web image-that is two similar hashes will indicate two visually similar sites.

The blockchain 112 has a primary version 112′ stored in server 111, and each of the computers 102, 104, 106 has a local version 112. The local versions 112 are periodically updated from the primary version 112′ from the server but can be accessed when the network 108 is inoperable.

The blacklist and cautious list blockchains are updated as explained in the method below.

The blockchains used in the present invention are private blockchains. As such, like public blockchains they are immutable, each node has a complete replica of the ledger and consensus is required. Unlike public blockchains, only authorised users can add data to the blockchain. Beneficially, private blockchains are more energy and resource efficient than public blockchains.

### Method

Referring to FIG. 2, a process 1000 according to the present invention is shown. At step 1002, a user accesses a website using the browser 109 equipped with software 110 configured to carry out the following steps of the present invention.

At step 1004, the software 110 checks the URL of the site visited against the white list blockchain 114 and the black list block chain 116.

If the URL is verified within the white list 114 the process terminates at step 1006 with the user being able to browse the site in confidence. An “approved”/“verified” etc indication may be provided to the user (or alternatively no visible indication may be an implicit indication that the site is approved).

If the URL is on the black list 116, the user is alerted to a malicious website at step 1008.

If the URL is neither on the white list 114 or the black list 116, the method continues to step 1010 whereby the website is checked for elements which may be indicative of a phishing site—for example any kind of data entry field, or more specifically a password field. If no such field is present, the process moves to step 1006. If not, the process moves to step 1012.

At step 1012, the software 110 takes a snapshot image of the web page. At step 1013, the image is processed using a pre-trained vision transformer to create a hash (i.e. a fixed-size representation of the captured visual features). Based on the capability of the local device (102, 104, 106), the hash generation process may be local, or alternatively remote (e.g., using cloud resources on the server 111). Local processing may be carried out utilizing local CPUs or GPUs (TensorFlow processing units (TPU) available on mobile phones such as the Google (RTM) Pixel (RTM), for example).

The process in step 1012 is configured to produce a hash that is representative of the web image—that is two similar hashes will indicate two visually similar sites. In this embodiment, the captured screenshot visual features are extracted using a pre-trained vision transformer (VGG—Visual Geometry Group model, for example). The generated feature vectors are then hashed using LSH (Locality Sensitive Hashing) to divide them into ‘buckets’ to perform the comparisons only on hashes in these buckets (i.e. similarity search). This reduces the search complexity from linear order O(N) to logarithmic order O(logN).

The process used at step 1012 is the same as that used to generate the hashes in the blockchain 112—or at least the result in terms of the form of the hash is the same.

At step 1014, the hash is compared to the protected hash blockchain 112. The produced hash is compared to existing protected hashes using the LSH algorithmic or similar similarity search techniques. If the comparison indicates a visual similarity between the hash of the snapshot image, and a hash of a protected website image, the process moves to step 1008. If not, the process moves to step 1006.

At step 1008, a user alert is produced to warn the user that a potential phishing site has been identified. The URL is added to the distributed ‘cautious list’ blockchain 118 at step 1016.

The ‘cautious list’ blockchain 118 keeps a counter against each suspicious URL. After a user interacts with the website, the website is reported, and the counter is incremented. When the counter reaches a predetermined threshold (configured by the service provider), the approval process (consensus process) is initiated. This is the ‘update black list’ sub-process 1017.

Consensus for the new addition to the cautious list is sought from the network at step 1018. If consensus is achieved, then the site URL is added to the blacklist block chain at step 1020. If not, the process ends.

Consensus is achieved with a limited number of approvers utilising techniques such as proof of authority, or PoA, consensus mechanism.

### Description of the Second Embodiment

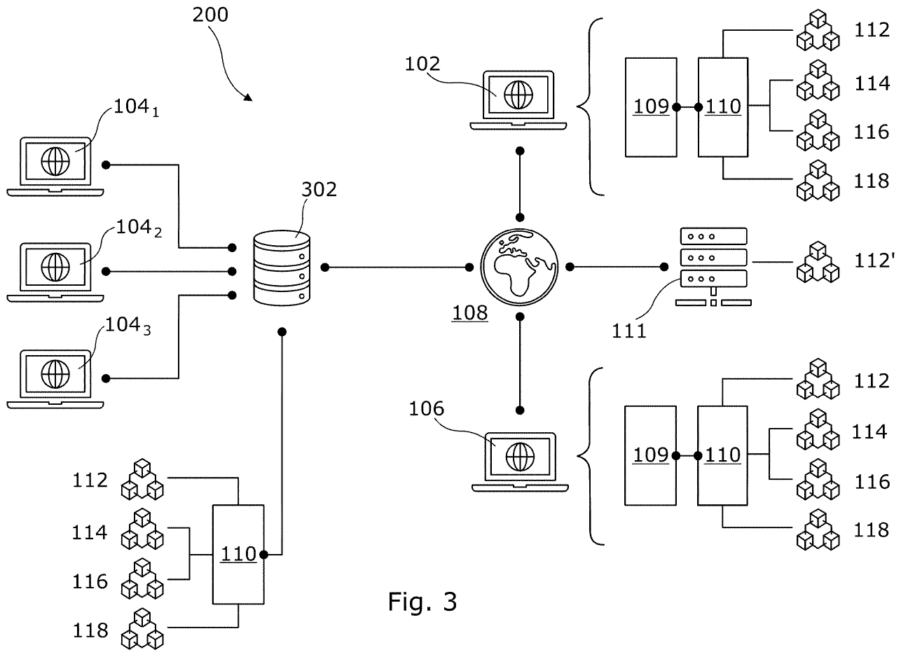

A second embodiment of the apparatus according to the present invention is shown in FIG. 3.

Referring to FIG. 3, apparatus 300 has many features common with the apparatus 100, and like features are numbered per FIG. 1. Rather than a direct connection to the internet, the local machines 104₁, 104₂, 104₃ are connected to the internet via a proxy server 302 which in turn is connected to the internet and the other machines 102, 106, 111.

Rather than the machine or machines 104 having software 110, the software 110 for carrying out the present invention is stored and executed on the proxy server 302 as part of the system application gateway. Other than this, the method operates in the same way. It will be noted that action taken by the application gateway will be effective across all machines 104 on the network.

As a variation to this embodiment, different treatment of cautious list sites may be used for different users. For example, enhanced security measures for client 1041 may be carried out is the user of that machine has access to particularly sensitive material (i.e. is a vulnerable user). In other words, the credentials on that particular machine may necessitate higher security. Cautious list sites would therefore be blocked for that user at step 1008. Other (less vulnerable) users may continue to access cautious list sites.

### Description of the Third Embodiment

In a third embodiment, which may be carried out as a modification of the first or second embodiment, the server 111 (or another machine connected to the network) is provided with an attack analysis program.

The program is configured to receive data concerning the local machines 102, 104, 106 and (for the modification to the second embodiment) the proxy server 302. The data concerning the local machines/proxy server comprises information about the location of the machines. By “location” we mean at least one of location in geographic terms, in terms of their location on the network (i.e. proximity to other network nodes) and/or in terms of their location within industries, organisations or subsidiaries of those industries or organisations.

As attacks are detected the attack analysis program compiles a database of attacks against the location data concerning the local machines. An attack (in this embodiment) is defined as the resemblance of a visited website to a protected (legitimate) website meets a pre-defined threshold. This resemblance is measured by comparison of the hashes of the visual appearance of those two sites (as discussed with respect to the first embodiment).

The attack analysis program then utilises this data to identify patterns in the attacks vs the location data. In response, once a pattern has been detected, local machines or owners/organisations operating local machines having the same or proximal location profiles are altered to the likelihood of an attack. In response, those local machines (or proxy servers) may operate enhanced security protocols such as blocking any cautious list sites or sites that fit a certain profile. For example, if a specific e.g. banking website is being utilised for an attack, any sites similar to that site (based on the image hash) is blocked.

By way of example, in a series of individual spear-phishing attacks, accounts departments and the local machines of senior accounts employees of an organisation may be attacked by duplicating a legitimate accounting or baking website which they typically access. Once a series of attacks of this type of user has been identified by the program identifying a pattern between attacks made and the location of the users, enhanced security may be employed by the organisation, blocking all accounts staff from accessing sites with image hashes similar to the site being used for the attack.

The attack analysis program may also control the local software programs (such as browser extensions or proxy server software) to block specific sites or types of site based on hashed image data.

In terms of pattern detection, the present invention utilises methods employed in the field of epidemiology. The SIR (Susceptible(S), Infected (I), Removed (R)) and SEIR (Susceptible(S), Exposed (E), Infected (I), Removed (R)) models from epidemiology were adapted to study the spread and speed of phishing attacks within digital environments. In the SIR model, users of a network are classified as Susceptible, Infected, or Recovered—corresponding to those who are vulnerable to phishing, those who have been compromised, and those who have resolved the attack (in this attack, detected and reported/recovered), respectively. The SEIR model adds an Exposed category, useful for capturing the state of users who have received phishing content but haven't yet acted upon it. These models help in understanding the dynamics of phishing campaigns, such as how quickly and widely a phishing attack can spread based on factors like the rate of accessed websites/links/URLs and user interactions with the malicious websites.

Network models and agent-based models offer detailed and customizable approaches for simulating and modelling phishing attacks to detect patterns. Network models consider the structure of relationships within an organization or social group, identifying potential key nodes or super-spreaders—individuals whose compromise could lead to widespread impact. This approach is beneficial for understanding how phishing links propagate/shared through an organization. Agent-based models, on the other hand, simulate the actions and interactions of individual users with unique behavioural traits. This allows for a granular analysis of how different users might respond to phishing attempts, aiding in the development of targeted anti-phishing training and measures to improve individual and organizational resilience against such attacks.

### Description of the Fourth Embodiment

The fourth embodiment is identical to the third embodiment with the exception that instead of location data, data concerning the user, or a user account representing the user, is used. The data concerning the user, or a user account representing the user, includes information such as the user's position within an organisation (in particular seniority), the types of data to which the user has access, the department or function within the company the user works in and so on. The data may also contain personal information such as age, gender and so on.

Therefore instead of (or as well as) identifying location vs attacks, the program identifies when certain classes of individuals (vulnerable individuals) are being attacked and takes action as discussed with respect to the third embodiment.

By way of example, C-suite executives may be targeted within a certain industry (for example banking or finance). The program can take action by then enhancing security for others in that vulnerable class as described above.

### Variations

As mentioned above, generation of the website image hash may be undertaken by the local machine 102, 104, 106 etc, or alternatively carried out in whole or in part by the remote server 111.

As well as URLs, the blockchains 114, 116, 118 may contain other data representative of a website—for example decentralised identifiers (DIDs) as discussed at https://www.w3.org/TR/2022/REC-did-core-20220719/.

In the two embodiments above, the software executing the present invention is provided on local machines or a proxy server. Other network devices could also host the software, or part of the functionality thereof, for example network routers, network switches with Deep Packet Inspection (DPI), Intrusion Detection Systems (IDS), Data Loss Prevention (DLP) systems, application gateways and so on. It will be understood that the software may be provided at any location on the network where web access can be monitored and controlled as provided for in the description above.

The above embodiments utilise the blockchain form of distributed store, database or ledger. It will be noted that other forms of distributed store or ledger may be used as alternatives to blockchain systems.

The above embodiments utilise a pre-trained vision transformer to generate the hash. In an alternative embodiment, a multimodal machine learning model may be used to generate the hash. The model may process only visual features, or as well as taking into account the visual/graphical aspects of the site, the multimodal machine learning model can also take into account at least one of the textual content and the URL to generate the hash. It may also process specific visual aspects e.g. the website colour profile, video or audio content.

As well as physical location, the attack analysis algorithm may recognise patterns in one or a combination of users' physical locations, their system features such as their vertical and horizontal connectivity to other protected users, and their system attributes.

1. A computer implemented method for the detection of malicious websites, the method comprising the steps of:
providing a plurality of client computing devices connected to a network;
providing a distributed store of legitimate website hashes, the distributed store of legitimate website hashes comprising hashed image data of legitimate websites, in the form of hashes representative of the visual features of an image of each respective legitimate website;
providing a database of potentially malicious websites;
providing a database of legitimate websites;
using a first client computing device of the plurality of client computing devices to visit a website;
undertaking a first verification step to verify the visited website against the database of potentially malicious websites, if the visited website can be verified against the database of potentially malicious websites alert the user, otherwise:
undertaking a second verification step to verify the visited website against the database of legitimate websites; and,
if the visited website cannot be verified against the database of legitimate websites:
capturing a graphical impression of the visited website as an image;
hashing the image of the visited website to create hashed image data of the visited website;
comparing the hashed image data of the visited website to the hashed image data of legitimate websites in the distributed store of legitimate website hashes to determine whether the visited website is visually similar to any of the legitimate websites;
if the visited website is visually similar to at least one of the legitimate websites:
adding the visited website to a cautious list distributed store;
seeking consensus across the network that the visited website from which the hashed image data is derived cannot be verified and is visually similar to a legitimate website; and,
if consensus is reached, adding the website to the database of potentially malicious websites.

2. The computer implemented method according to claim 1, wherein the distributed store of legitimate website hashes is a blockchain.

3. The computer implemented method according to claim 1, wherein the cautious list distributed store is a blockchain.

4. The computer implemented method according to claim 1, wherein the database of potentially malicious websites and/or the database of legitimate websites each comprise website address data.

5. The computer implemented method according to claim 1, wherein the database of potentially malicious websites and/or the database of legitimate websites are each blockchains.

6. The computer implemented method according to claim 1, wherein the database of potentially malicious websites and/or the database of legitimate websites are read only blockchains for a majority subset of the plurality of client computing devices.

7. The computer implemented method according to claim 1, wherein the step of hashing the image of the visited website comprises the step of generating a hash using an algorithm in which visual features are extracted using a pre-trained vision transformer.

8. The computer implemented method according to claim 7, wherein feature vectors generated by the pre-trained vision transformer are hashed using LSH (Locality Sensitive Hashing).

9. The computer implemented method according to any claim 1, further comprising the steps of:
providing a server connected to the network;
storing a primary version of the blockchain of legitimate website hashes on the server;
storing local versions of the blockchain of legitimate website hashes on at least some of the plurality of client computing devices; and,
periodically updating the local versions of the blockchain of legitimate website hashes from the primary version of the blockchain of legitimate website hashes.

10. The computer implemented method according to claim 1, wherein consensus is achieved with a limited subset of approvers.

11. The computer implemented method according to claim 10, wherein consensus is achieved using the proof of authority consensus mechanism.

12. The computer implemented method according to claim 1, further comprising the steps of:
providing a server connected to the network;
undertaking the step of hashing on behalf of or more client computing devices using the server.

13. The computer implemented method according to 1, wherein the network is connected to the internet.

14. The computer implemented method according to claim 1, further comprising the step of:
undertaking another verification step, prior to the second verification step, by checking whether the website comprises user entry fields, if the website does not comprise user entry fields, stopping the method.

15. The computer implemented method according to claim 14, wherein the verification steps are carried out by the first client computing device.

16. The computer implemented method according to claim 15, wherein the verification steps are carried out by a browser extension stored and executed on the first client computing device.

17. The computer implemented method according to claim 1, wherein the first client computing device is connected to the network via a proxy server, and further wherein the verification steps are carried out by the proxy server.

18. The computer implemented method according to claim 17, wherein at least one further client computing device is connected to the network via the proxy server, and the proxy server is configured to control access to websites from each of the client computing devices connected to the proxy server based on the verification steps.

19. The computer implemented method according to claim 1, further comprising the steps of:
storing data about each of the plurality of client computing devices and/or users of each of the client computing devices;
creating a database of visited websites added to the cautious list distributed store against the data about the client computing device from which the website was visited;
identifying a pattern in the database identifying a class of client computing devices or users thereof under attack;
producing an alert to users or organisation of users in the same class.

20. The computer implemented method according to claim 19, wherein the data about each of the plurality of client computing devices and/or users of each of the client computing devices comprises one or more of:
the geographical location of the local machine;
the network location of the local machine;
the organisation in which the local machine is deployed;
the industry in which the local machine is deployed;
the position of the user of the local machine;
the department of the user of the local machine;
the level of access the user of the local machine has to sensitive data; and,
personal details of the user of the local machine.

21. A data processing system comprising means for carrying out the method of claim 1.

22. A computer program comprising instructions which, when the program is executed by a computer, cause the computer to carry out the method of claim 1.

23. A computer-readable medium comprising instructions which, when executed by a computer, cause the computer to carry out the method of claim 1.
